(19) United States
(12) Patent Application Publication
(10) Pub. No.: US 2024/0116380 A1
(43) Pub. Date: Apr. 11, 2024

(54) SOLAR CHARGING SYSTEM

(71) Applicant: TOYOTA JIDOSHA KABUSHIKI KAISHA, Toyota-shi (JP)

(72) Inventors: Yuma MIYAMOTO, Miyoshi-shi (JP); Yukinori MURAKAMI, Toyota-shi (JP)

(73) Assignee: TOYOTA JIDOSHA KABUSHIKI KAISHA, Toyota-shi (JP)

(21) Appl. No.: 18/365,282

(22) Filed: Aug. 4, 2023

(30) Foreign Application Priority Data
Oct. 11, 2022 (JP) 2022-163528

(51) Int. Cl. B60L 53/51; B60L 1/00; H02J 7/35

(52) U.S. Cl. CPC B60L 53/51; B60L 1/00; H02J 7/35

(57) ABSTRACT

A solar charging system mounted on a vehicle, comprising: a solar panel; a drive battery used for driving the vehicle; an auxiliary battery for supplying electric power to an in-vehicle device operating during parking; and a control unit for controlling electric power of the solar panel, the drive battery, and the auxiliary battery, wherein the control unit controls, during parking, a charging process for supplying generated electric power of the solar panel to the drive battery and a discharging process for supplying electric power of the drive battery to an auxiliary system including the auxiliary battery and the in-vehicle device so as not to be executed at the same time.

### CROSS-REFERENCE TO RELATED APPLICATION

This application claims priority to Japanese Patent Application No. 2022-163528 filed on Oct. 11, 2022 incorporated herein by reference in its entirety.

### BACKGROUND

### 1. Technical Field

The present disclosure relates to a solar charging system that controls supply of electric power generated by a solar panel mounted on a vehicle.

### 2. Description of Related Art

Japanese Unexamined Patent Application Publication No. 2021-083248 (JP 2021-083248 A) discloses a solar charging system in which, when a solar panel is in a state in which electric power can be generated, electric power is supplied from the solar panel to an auxiliary system and electric power that is actually generated by the solar panel is derived, and when the derived actually generated electric power is equal to or more than a specified value, a drive battery is further charged by the electric power generated by the solar panel.

### SUMMARY

Generally, when a vehicle is in a parked state, electric power is supplied from an auxiliary battery to equipment that operates a service that is provided when the vehicle is parked. Further, in order to suppress the auxiliary battery from going dead, control for supplying electric power of the drive battery to the equipment that operates the service that is provided when the vehicle is parked, is also performed as necessary.

Here, when a process of charging the electric power generated by the solar panel to the drive battery and a process of supplying the electric power of the drive battery to the equipment that operates the service that is provided when the vehicle is parked are independently controlled, there arises a problem that a case increases in which electric power loss in a boost/step down direct current (DC)-DC converter or the like occurs, and thus the charging efficiency is reduced. Therefore, there is room for further study on a charging method of solar generated electric power to be implemented in a solar charging system when the vehicle is parked.

The present disclosure has been made in view of the above issue, and an object of the present disclosure is to provide a solar charging system and the like capable of improving the charging efficiency of electric power generated by a solar panel when a vehicle is parked.

In order to solve the above issue, an aspect of the present disclosure is a solar charging system mounted on a vehicle. The solar charging system includes: a solar panel; a drive battery that is used for driving the vehicle; an auxiliary battery that supplies electric power to an in-vehicle device operating when the vehicle is parked; and a control unit that controls electric power of the solar panel, the drive battery, and the auxiliary battery. The control unit performs control such that, when the vehicle is parked, a charging process of supplying electric power generated by the solar panel to the drive battery, and a discharging process of supplying the electric power of the drive battery to the auxiliary battery and an auxiliary system including the in-vehicle device, are not performed simultaneously.

In accordance with the solar charging system according to the present disclosure, electric power that is charged to the drive battery, the electric power being generated by the solar panel and boosted, is not directly stepped down and supplied to the in-vehicle device. Therefore, it is possible to improve the charging efficiency of the electric power generated by the solar panel when the vehicle is parked.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a solar charging system according to the present embodiment;

FIG. 2A is a process flow chart of the charge control performed by the solar charging system;

FIG. 2B is a process flow chart of the charge control performed by the solar charging system;

FIG. 3 is a process flow chart of charge control of an application executed by the solar charging system; and

FIG. 4 is a block diagram illustrating another schematic configuration of the solar charging system according to the present embodiment.

### DETAILED DESCRIPTION OF EMBODIMENTS

In the solar charging system according to the present disclosure, the charging of the drive battery using the generated electric power of the solar panel during parking and the taking-out of the electric power from the drive battery to the auxiliary system due to the lowering of the electric power of the auxiliary battery are controlled so as not to be executed in parallel.

Hereinafter, an embodiment of the present disclosure will be described in detail with reference to the drawings.

### EMBODIMENT

### Configuration

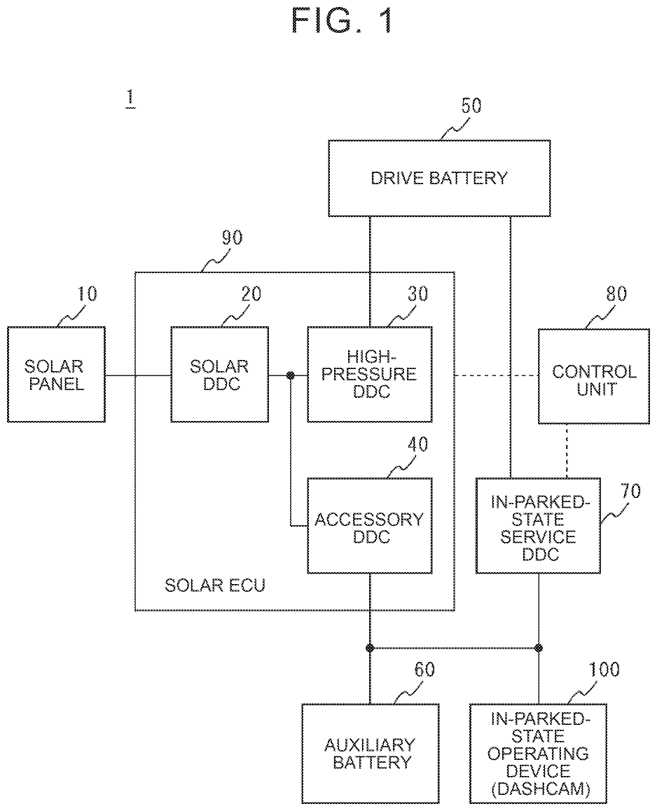

FIG. 1 is a block diagram illustrating a schematic configuration of a solar charging system 1 according to an embodiment of the present disclosure. The solar charging system 1 illustrated in FIG. 1 includes a solar panel 10, a solar DDC 20, a high-voltage DDC 30, an auxiliary DDC 40, a drive battery 50, an auxiliary battery 60, an in-parked-state service DDC 70, and a control unit 80. The auxiliary machine DDC 40, the auxiliary battery 60, and the in-parked-state service DDC 70 are connected to the in-parked-state operating device 100. The solar charging system 1 can be mounted on a vehicle or the like.

The solar panel 10 is a power generation device that generates electric power by being irradiated with sunlight, and is typically a solar cell module that is an aggregate of solar cells. The solar panel 10 can be installed in, for example, a roof of a vehicle (solar roof). The solar panel 10 is connected to a solar DDC 20. The electric power generated by the solar panel 10 is outputted to the solar DDC 20. Note that the number of solar panels 10 installed in the vehicle is not limited to one, and may be a plurality.

The solar DDC 20 is a DCDC converter for supplying the electric power generated by the solar panel 10 to the high-voltage DDC 30 and the auxiliary DDC 40. The solar DDC 20 can convert the output voltage of the solar panel 10, which is the input voltage, into a predetermined voltage (step-up or step-down) and output the converted voltage to the high-voltage DDC 30 and the auxiliary DDC 40 when supplying power.

The high-voltage DDC 30 is a DCDC converter for supplying power outputted by the solar DDC 20 to the drive battery 50. The high-voltage DDC 30 can boost the output voltage of the solar DDC 20, which is the input voltage, to a predetermined voltage and output it to the drive battery 50 when supplying electric power.

The auxiliary machine DDC 40 is a DCDC converter for supplying power outputted by the solar DDC 20 to the auxiliary battery 60 and the in-parked-state operating device 100. The auxiliary machine DDC 40 can step down the output voltage of the solar DDC 20, which is the input voltage, to a predetermined voltage and output it to the auxiliary battery 60 and the in-parked-state operating device 100 when supplying electric power.

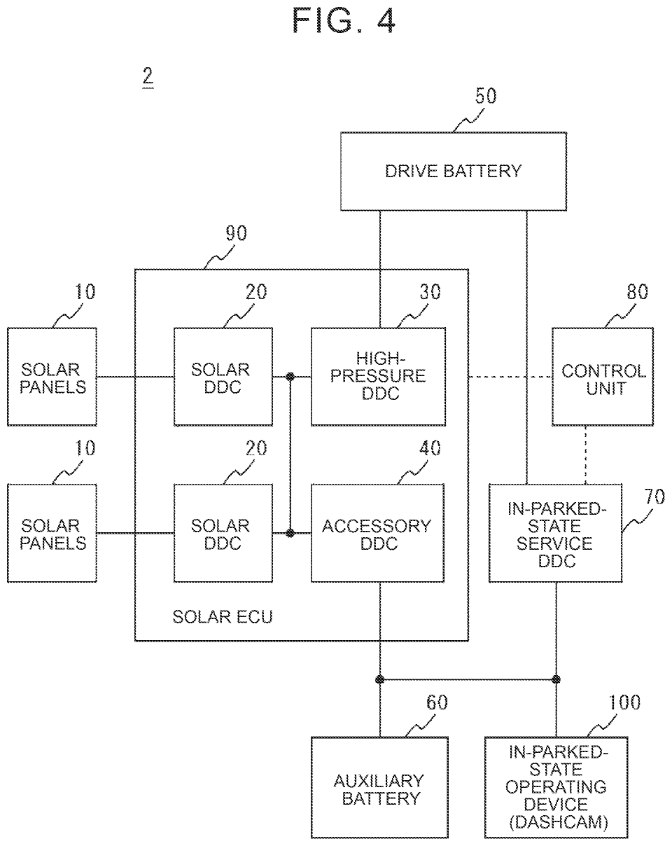

The solar DDC 20, high pressure DDC 30, and accessory DDC 40 described above typically comprise a solar Electronic Control Unit (ECU) 90. When the plurality of solar panels 10 are installed in vehicles, a plurality of solar DDC 20 may be provided in parallel to individually control the respective solar panels 10 as in the solar charging system 2 illustrated in FIG. 4. Further, the solar ECU 90 may be integrally formed with the solar panel 10 or may be integrally formed with other power train components.

The drive battery 50 is a secondary battery configured to be chargeable and dischargeable, such as a lithium-ion battery or a nickel-metal hydride battery. The drive battery 50 is connected to the high-voltage DDC 30 so as to be chargeable by electric power outputted from the high-voltage DDC 30. The drive battery 50 mounted on the vehicle is a battery capable of supplying electric power necessary for the operation of a main device (not shown) for driving the vehicle, such as a starter motor or an electric motor. The rated voltage of the drive battery 50 is higher than that of the auxiliary battery 60.

The auxiliary battery 60 is a secondary battery configured to be chargeable and dischargeable, such as a lithium-ion battery or a lead-acid battery. The auxiliary battery 60 is connected to the auxiliary DDC 40 so as to be chargeable by electric power outputted from the auxiliary DDC 40. The auxiliary battery 60 mounted on the vehicle is a battery capable of supplying electric power necessary for the operation of an auxiliary device (not shown) other than for driving the vehicle, such as lights such as headlamps and indoor lamps, air conditioners such as heaters and coolers, and devices such as automatic driving and advanced driving support, and electric power necessary for the operation of the in-parked-state operating device 100, which will be described later. In the auxiliary battery 60, a rated voltage (for example, 12 V) lower than that of the drive battery 50 is set. The output-side system of the auxiliary machine DDC 40 to which the auxiliary battery 60, the auxiliary machine (not shown), the in-parked-state operating device 100, and the like are connected is hereinafter referred to as an “auxiliary system”.

The in-parked-state service DDC 70 is a DCDC converter for supplying at least the electric power stored in the drive battery 50 to the in-parked-state operating device 100. When the auxiliary battery 60 needs to be charged, the in-parked-state service DDC 70 can also charge the auxiliary battery 60 by the electric power of the drive battery 50. The in-parked-state service DDC 70 can reduce the output voltage of the drive battery 50, which is the input voltage, to a predetermined voltage and output the voltage to the in-parked-state operating device 100 (and the auxiliary battery 60 and the like) when supplying electric power.

In the present embodiment, a configuration has been described in which the in-parked-state service DDC 70 is provided as an independent equipment dedicated to parking. However, the configuration of the in-parked-state service DDC 70 can be omitted by providing the function executed by the in-parked-state service DDC 70 to other DCDC converters.

The control unit 80 controls the power of the solar panel 10, the drive battery 50, and the auxiliary battery 60 by controlling at least the high-voltage DDC 30, the auxiliary DDC 40, and the in-parked-state service DDC 70. Specifically, the control unit 80 controls the power supplied from the solar panel 10 to the drive battery 50 by controlling the operating status of the high-voltage DDC 30. In addition, the control unit 80 controls the power supplied from the solar panel 10 to the auxiliary battery 60 and the in-parked-state operating device 100 by controlling the operating status of the auxiliary DDC 40. In addition, the control unit 80 controls the operation status of the in-parked-state service DDC 70 to control the power supplied from the drive battery 50 to the in-parked-state operating device 100 (and the auxiliary battery 60 and the like).

Note that the control unit 80 may be realized as a function of a HV-ECU (not shown) that performs hybrid-control of vehicles, may be realized as a function of a solar ECU 90, or may be realized by a ECU other than ECU. ECU for implementing the control unit 80 is typically configured to include a processor, a memory, an input/output interface, and the like, and the processor reads and executes a program stored in the memory, so that the above-described various controls can be implemented.

The in-parked-state operating device 100 is an in-vehicle device for executing a predetermined in-parking service to be provided to a user or the like when the vehicle is in a parking state. The in-parked-state operating device 100 can be operated by electric power supplied from the solar panel 10 or the auxiliary battery 60. As the in-parked-state operating device 100, a dashboard camera (dashcam) or the like can be exemplified.

### Control

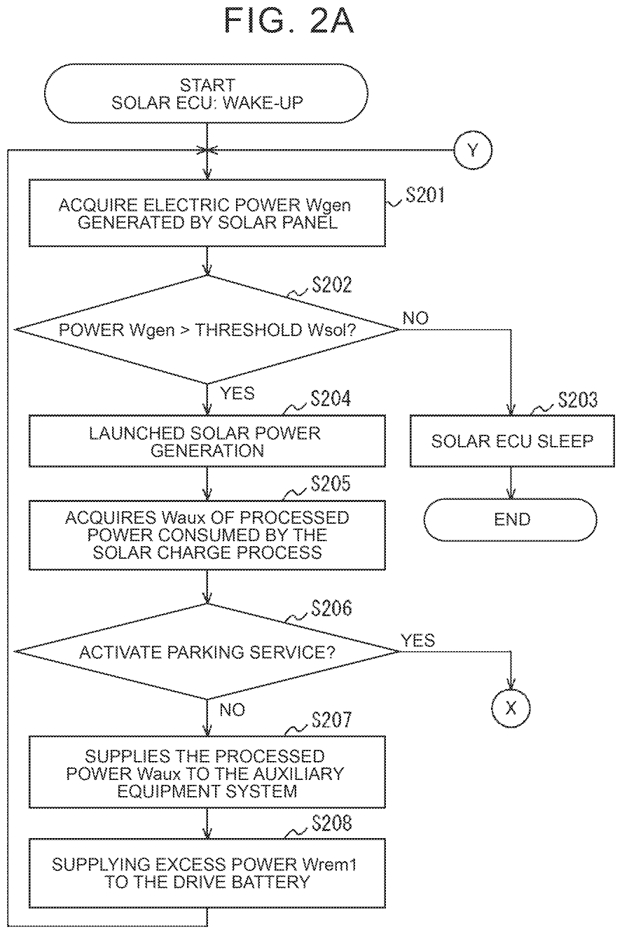

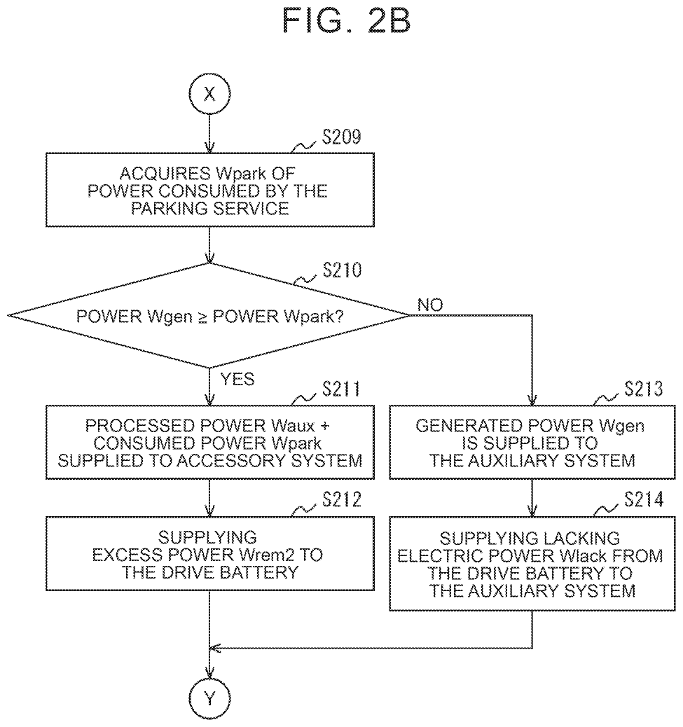

Referring now further to FIG. 2A and FIG. 2B, the control performed by the solar charging system 1 will now be described. FIG. 2A and FIG. 2B are flow charts for explaining a charge control process executed by the control unit 80 and the solar ECU 90 of the solar charging system 1. The process of FIG. 2A and the process of FIG. 2B are connected by the couplers X and Y.

The charge control illustrated in FIG. 2A and FIG. 2B is started when, for example, a solar ECU 90 that has stopped (sleeps) some or all of its functions in a state in which the vehicle is parked is brought into a state in which the solar panel 10 can generate electricity by irradiation of sunlight, and thus the stopped function is activated (wakeup).

### S201

The solar ECU 90 acquires a generated electric power Wgen which is electric power generated by the solar panel 10. The generated electric power Wgen can be derived from a voltage/current output by the solar panel 10. Note that the generated power Wgen may be notified to the control unit 80. When the solar ECU 90 acquires the generated electric power Wgen of the solar panel 10, the process proceeds to S202.

### S202

The solar ECU 90 determines whether the generated power Wgen of the solar panel 10 exceeds a predetermined Wsol. This determination is made to determine whether the solar panel 10 is generating sufficient power to enable efficient charge control to be performed. For example, if Wgen of power generated by the solar panel 10 is less than the power required for the charging operation of the solar charging system 1, discharging from the auxiliary battery 60 occurs, and the amount of battery power consumed is larger than the amount of power that can be obtained by the solar power generation, so that the charging control is not meaningful. Therefore, the threshold Wsol can be set to be equal to or higher than the electric power that can be charged and controlled without discharging from the auxiliary battery 60.

If the solar ECU 90 determines that the generated power Wgen exceeds the threshold Wsol (Wgen>Wsol) (S202, Yes), the process proceeds to S204. On the other hand, if the solar ECU 90 determines that the generated power Wgen does not exceed the threshold Wsol (Wgen≤Wsol) (S202, No), the process proceeds to S203.

### S203

Since the solar ECU 90 cannot perform efficient charge control using the generated electric power Wgen of the solar panel 10, the operation of some or all of the predetermined functions is stopped to sleep. As a result, the charging control ends.

### S204

The solar ECU 90 starts power generation by the solar panel 10. That is, the solar ECU 90 starts outputting the generated power Wgen of the solar panel 10 to the auxiliary battery 60 or the like. For this power generation, a well-known maximum-power-point tracking (MPPT) control or the like is used. When power generation by the solar panel 10 is started by the solar ECU 90, the process proceeds to S205.

### S205

The control unit 80 acquires the processing power Waux consumed in the processing of charging the auxiliary battery 60 (hereinafter referred to as “solar charging processing”). More specifically, the processing power Waux is power obtained by summing the electric power required for the control operation of ECU or the like involved in executing the solar charging process and the electric power charged in the auxiliary battery 60. The processed power Waux can be derived from the outflow current and the output voltage of the auxiliary battery 60 detected by the control unit 80 or the like. Further, the processed power Waux is notified to the solar ECU 90. When the processing power Waux is acquired by the control unit 80, the processing proceeds to S206.

### S206

The control unit 80 determines whether or not the parking service is activated in the vehicle. When the in-parking service is activated, it means that at least the in-parked-state operating device 100 is in operation.

When the control unit 80 determines that the in-parking-service is activated (S206, Yes), the process proceeds to S209. On the other hand, when the control unit 80 determines that the in-parking-service is not activated (S206, No), the process proceeds to S207.

### S207

The control unit 80 and the solar ECU 90 provide the processed power Waux of the generated power Wgen of the solar panel 10 to the auxiliary system. When the processing power Waux is supplied to the auxiliary system by the control unit 80 and the solar ECU 90, the processing proceeds to S208.

### S208

The control unit 80 and the solar ECU 90 supply the surplus power Wrem1 that is not supplied to the auxiliary power system among the generated power Wgen of the solar panel 10 to the drive battery 50. The surplus power Wrem1 is power obtained by subtracting the processed power Waux from the generated power Wgen (Wrem1=Wgen−Waux). When the surplus power Wrem1 is supplied to the drive battery 50 by the control unit 80 and the solar ECU 90, the process proceeds to S209.

### S209

The control unit 80 acquires Wpark of power consumed in the in-parking service. Specifically, the power consumption Wpark is power consumed by the in-parked-state operating device 100. This power-consumption Wpark may be given in advance as a fixed value, or may be derived from the outflow current and the output voltage of the auxiliary battery 60 detected by the control unit 80 or the like. In addition, the power-consumption Wpark is notified to the solar ECU 90. When the power-consumption Wpark is acquired by the control unit 80, the process proceeds to S210.

### S210

The solar ECU 90 determines whether the generated power Wgen of the solar panel 10 is equal to or greater than Wpark of power consumed in the in-parking service. This determination is made in order to determine whether the parking service can be activated only by supplying the generated power Wgen.

When the solar ECU 90 determines that the generated electric power Wgen is equal to or higher than the consumed electric power Wpark (Wgen≥Wpark) (S210, Yes), the process proceeds to S211. On the other hand, when the solar ECU 90 determines that the generated electric power Wgen is less than the consumed electric power Wpark (Wgen<Wpark) (S210, No), the process proceeds to S213.

### S211

The control unit 80 and the solar ECU 90 provide power (=Waux+Wpark) obtained by adding the processed power Waux and the consumed power Wpark among the generated power Wgen of the solar panel 10 to the auxiliary system. When the control unit 80 and the solar ECU 90 supply the electric power obtained by adding the consumed electric power Wpark to the processed electric power Waux to the auxiliary system, the process proceeds to S212.

### S212

The control unit 80 and the solar ECU 90 supply the surplus power Wrem2 that is not supplied to the auxiliary power system among the generated power Wgen of the solar panel 10 to the drive battery 50. The surplus power Wrem2 is power obtained by subtracting the processed power Waux and the consumed power Wpark from the generated power Wgen (Wrem2=Wgen−(Waux+Wpark). When the surplus power Wrem2 is supplied to the drive battery 50 by the control unit 80 and the solar ECU 90, the process proceeds to S201.

### S213

The control unit 80 and the solar ECU 90 provide the generated electric power Wgen of the solar panel 10 to the auxiliary system. When the generated electric power Wgen is supplied to the auxiliary system by the control unit 80 and the solar ECU 90, the process proceeds to S214.

### S214

The control unit 80 supplies the insufficient power Wlack, which is insufficient only by the generated power Wgen of the solar panel 10 among the electric power required for the auxiliary system, from the drive battery 50 to the auxiliary system via the in-parked-state service DDC 70. This insufficient power Wlack is electric power obtained by subtracting the generated electric power Wgen of the solar panel 10 from the electric power obtained by adding Wpark of electric power consumed by the service during parking to the processing electric power Waux required for the solar charging process (Wlack=(Waux+Wpark)−Wgen). When the insufficient power Wlack is supplied from the drive battery 50 to the auxiliary system by the control unit 80, the process proceeds to S201.

As described above, by determining and appropriately controlling the necessary electric power in each place, it is possible to prevent the charging process of supplying the generated electric power of the solar panel 10 to the drive battery 50 during parking and the discharging process of supplying the electric power of the drive battery 50 to the in-parked-state operating device 100 at the same time. Accordingly, the charging efficiency of the electric power generated by the solar panel 10 during parking can be improved.

### Application Example

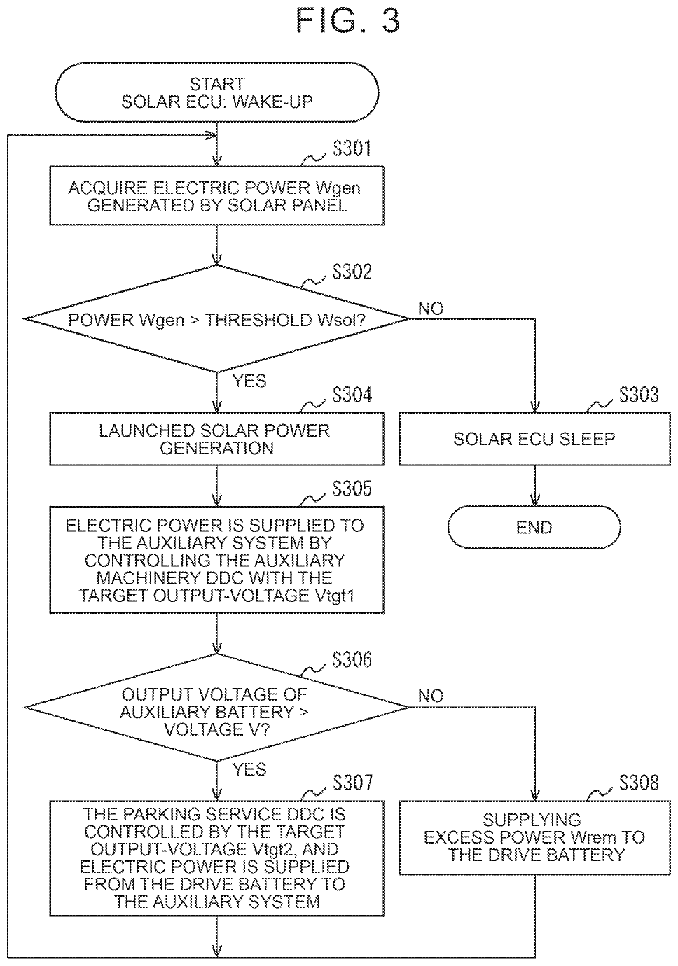

In the above FIGS. 2A and 2B, charge control based on power control (current indication) has been described. In this application example, the charge control based on the voltage control (voltage instruction) will be described with reference to FIG. 3. FIG. 3 is a flow chart for explaining a charge control process executed by the control unit 80 and the solar ECU 90 of the solar charging system 1.

For example, when a solar ECU 90 that has stopped (sleeps) some or all of its functions in a parked state or the like is brought into a state in which the solar panel 10 can generate electric power by irradiation of sunlight, and the stopped function is activated (wakeup), the charge control of the application illustrated in FIG. 3 is started.

### S301

The solar ECU 90 acquires the generated power Wgen of the solar panel 10. When the generated electric power Wgen is acquired by the solar ECU 90, the process proceeds to S302.

### S302

The solar ECU 90 determines whether the generated power Wgen of the solar panel 10 exceeds a predetermined Wsol. This determination is made to determine whether the solar panel 10 is generating sufficient power to enable efficient charge control to be performed. The thresholds Wsol are as described above.

If the solar ECU 90 determines that the generated power Wgen exceeds the threshold Wsol (Wgen>Wsol) (S302, Yes), the process proceeds to S304. On the other hand, if the solar ECU 90 determines that the generated power Wgen does not exceed the threshold Wsol (Wgen≤Wsol) (S302, No), the process proceeds to S303.

### S303

Since the solar ECU 90 cannot perform efficient charge control using the generated electric power Wgen of the solar panel 10, the operation of some or all of the predetermined functions is stopped to sleep. As a result, the charging control ends.

### S304

The solar ECU 90 starts power generation by the solar panel 10. That is, the solar ECU 90 starts outputting the generated power Wgen to the auxiliary battery 60 or the like. For this power generation, a well-known maximum-power-point tracking (MPPT) control or the like is used. When power generation by the solar panel 10 is started by the solar ECU 90, the process proceeds to S305.

### S305

The control unit 80 and the solar ECU 90 control the output voltage of the auxiliary machine DDC 40 to be the target output voltage Vtgt1, and supply the generated power Wgen of the solar panel 10 to the auxiliary system. The target output voltage Vtgt1 is appropriately set based on the rated voltage of the auxiliary battery 60 or the like. When the auxiliary machine DDC 40 is controlled by the control unit 80 and the solar ECU 90 at the target output-voltage Vtgt1 and the generated electric power Wgen is supplied to the auxiliary system, the process proceeds to S306.

### S306

The control unit 80 determines whether or not the voltage actually output by the auxiliary battery 60 exceeds the predetermined voltage V based on the control by the target output voltage Vtgt1. This determination is made in order to determine whether or not the auxiliary battery 60 is an electric storage amount that needs to be charged. Therefore, the voltage V is appropriately set based on the rated voltage of the auxiliary battery 60 or the like.

When the control unit 80 determines that the output voltage of the auxiliary battery 60 exceeds the predetermined voltage V (S306, Yes), the process proceeds to S307. On the other hand, when the control unit 80 determines that the output voltage of the auxiliary battery 60 does not exceed the predetermined voltage V (S306, No), the process proceeds to S308.

### S307

The control unit 80 and the solar ECU 90 control the output voltage of the in-parked-state service DDC 70 so as to be the target output voltage Vtgt2, and supply the electric power of the drive battery 50 to the auxiliary system. The target output voltage Vtgt2 is appropriately set based on the rated voltage of the auxiliary battery 60, the target output voltage Vtgt1, and the like. When the control unit 80 controls the in-parked-state service DDC 70 at the target output-voltage Vtgt2 and supplies electric power from the drive battery 50 to the auxiliary system, the process proceeds to S301.

### S308

The control unit 80 and the solar ECU 90 supply the surplus power Wrem that is not supplied to the auxiliary power system among the generated power Wgen of the solar panel 10 to the drive battery 50. The surplus electric power Wrem is electric power obtained by subtracting the electric power W output to the auxiliary system based on the control by the target output voltage Vtgt1 from the generated electric power Wgen (Wrem=Wgen−W). When the surplus power Wrem is supplied to the drive battery 50 by the control unit 80 and the solar ECU 90, the process proceeds to S301.

As in the application example, the charging efficiency of the electric power generated by the solar panel 10 during parking can also be improved by the control by the voltage.

### Operations and Effects

As described above, according to the solar charging system 1 of the embodiment of the present disclosure, during parking, the charging process of supplying the generated power Wgen of the solar panel 10 to the drive battery 50 and the discharging process of supplying the power of the drive battery 50 to the auxiliary equipment system including the in-parked-state operating device 100 are controlled so as not to be executed at the same time.

This control prevents power transfer with large loss such as boosting the generated power Wgen of the solar panel 10 to step down the electric power charged in the drive battery 50 as it is and supplying the electric power to the auxiliary system. Therefore, it is possible to improve the charging efficiency of the electric power generated by the solar panel 10 during parking.

Although an embodiment of the disclosed technology has been described above, the present disclosure can be regarded as not only a solar charging system but also a method performed by the solar charging system, a program of the method, a computer-readable non-transitory storage medium storing the program, a vehicle including the solar charging system, and the like.

The solar charging system of the present disclosure can be used for a vehicle or the like that charges a battery using electric power generated by a solar panel.

What is claimed is:

1. A solar charging system mounted on a vehicle, the solar charging system comprising:
a solar panel;
a drive battery that is used for driving the vehicle;
an auxiliary battery that supplies electric power to an in-vehicle device operating when the vehicle is parked; and
a control unit that controls electric power of the solar panel, the drive battery, and the auxiliary battery, wherein the control unit performs control such that, when the vehicle is parked, a charging process of supplying electric power generated by the solar panel to the drive battery, and a discharging process of supplying the electric power of the drive battery to the auxiliary battery and an auxiliary system including the in-vehicle device, are not performed simultaneously.

2. The solar charging system according to claim 1, wherein when the electric power generated by the solar panel is equal to or more than power consumption of the auxiliary system, the control unit performs control such that the electric power generated by the solar panel is able to be supplied to the auxiliary battery, the auxiliary system, and the drive battery, and when the electric power generated by the solar panel is less than the power consumption of the auxiliary system, the control unit performs control such that the electric power generated by the solar panel is able to be supplied to the auxiliary system.

3. The solar charging system according to claim 2, wherein when the electric power generated by the solar panel is equal to or more than the power consumption of the auxiliary system, electric power that is not consumed by the auxiliary system out of the electric power generated by the solar panel is supplied to the drive battery by the control unit.

4. The solar charging system according to claim 2, wherein when the electric power generated by the solar panel is less than the power consumption of the auxiliary system, electric power that is insufficient with the electric power generated by the solar panel with respect to the power consumption of the auxiliary system is supplied from the drive battery by the control unit.

5. The solar charging system according to claim 1, wherein in a case where the electric power generated by the solar panel is supplied to the auxiliary system based on a predetermined target output voltage, when an output voltage of the auxiliary battery is less than a predetermined voltage, the electric power of the drive battery is supplied to the auxiliary system in addition to the electric power generated by the solar panel, by the control unit, and when the output voltage of the auxiliary battery has a predetermined voltage abnormality, electric power that is not consumed by the auxiliary system out of the electric power generated by the solar panel is supplied to the drive battery by the control unit.
